(19) United States
(12) Patent Application Publication
(10) Pub. No.: US 2009/0317520 A1
(43) Pub. Date: Dec. 24, 2009

(54) Vegetable Containing Food Product and Method of Making

(75) Inventors: Dimitris LYKOMITROS, Athens (GR); David Wallice GRAHAM, Carrollton, TX (US); Brian Peter JACOBY, Dallas, TX (US)

Correspondence Address: CARSTENS & CAHOON, LLP, P O BOX 802334, DALLAS, TX, 75380, US

(73) Assignee: FRITO-LAY NORTH AMERICA, INC., Plano, TX (US)

(21) Appl. No.: 12/141,526

(22) Filed: Jun. 18, 2008

(51) Int. Cl. A23P 1/08; A23L 1/2165; A23L 1/05; A23L 1/212; A23L 1/0524; A23L 1/0562; A23L 1/0532; A23L 1/0522; A23L 1/36; A23L 1/10

(52) U.S. Cl. 426/93; 426/637; 426/573; 426/629; 426/618; 426/291; 426/575; 426/576; 426/577; 426/578; 426/96

(57) ABSTRACT

A method is disclosed for producing a vegetable containing half product and final product. The vegetable containing food products have a high content of non-potato vegetable puree and can be made to resemble French fries. The vegetable containing food product and half product can be easily inserted into the supply chain of a quick service restaurant for efficient delivery to the consumer.

### BACKGROUND OF THE INVENTION

1. Technical Field

The present invention relates to a vegetable-containing food product and half product. The present invention also relates to a method of making a vegetable containing food product and half product.

2. Background

French fries are staple side dish items in the restaurant industry, especially in the quick service restaurant (QSR) industry. French fries generally comprise baton or matchstick shaped potato slices that have been cooked, typically fried, until they have a crispy and golden brown surface, and a warm, soft, moist interior. After they are cooked, the French fries are typically seasoned with salt and any number of other seasonings in order to create a savory side dish that is commonly ordered along with a hamburger. The French fries' long thin shapes allow them to be grouped neatly together within a paper cup or other similar receptacle and delivered to the consumer. The consumer is then able to easily access and consume the French fries.

QSR establishments that sell French fries typically purchase their French fries as half products. In other words, potatoes are blanched, peeled, cut, partially fried (or par-fried) and then frozen. This entire process of creating half products takes place in a large scale commercial processing facility. These frozen half products are packaged in bulk and shipped out to individual QSRs, where they are fried a second time before being served to consumers. This supply chain method takes advantage of efficiencies available for commercial scale processes and allows the QSRs to deliver a high quality product to consumers at a better value.

Many consumers in recent years have devoted more attention to their diet and health. Some of these consumers perceive French fries as an unhealthy food item. These consumers base their belief in part on the oil content of the French fries that results from the frying process. These consumers also tend to prefer non-potato vegetables over potatoes. As such, some consumers avoid ordering French fries at QSR restaurants. Because French fries are often the only side dish choice at many QSR chains, consumers that will not order French fries are often left without a suitable alternative or replacement dish. Additionally, when alternative side items are offered, such as a small side salad or sweet potato fries, these can be unpopular in consumers' minds either because they are not savory like French fries, or because they are not perceived as a healthy alternative to French fries.

Therefore, it would be an advance in the art to provide consumers with a side dish that is perceived by most consumers as a healthy alternative side dish to the French fry, but which is just as savory and delicious as a French fry. It should also have the capability to fit within the typical supply chain used by QSR establishments.

### SUMMARY OF THE INVENTION

The invention comprises a process for producing a vegetable containing food half product and final product, and method of making both. First, a non-potato vegetable puree is combined with other ingredients to produce a vegetable paste. The vegetable paste is extruded and cut into pre-forms. In one embodiment, the pre-forms are individually quick frozen following extrusion and cutting. The pre-forms are breaded and cooked to a desired moisture content. The moisture content of the half product is higher than the moisture content of the final product. The half products can be frozen and shipped to QSR establishments, where they can be heated and served to consumers in a manner similar to the way French fries are heated and served.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart showing the process for producing the vegetable containing food products of the present invention.

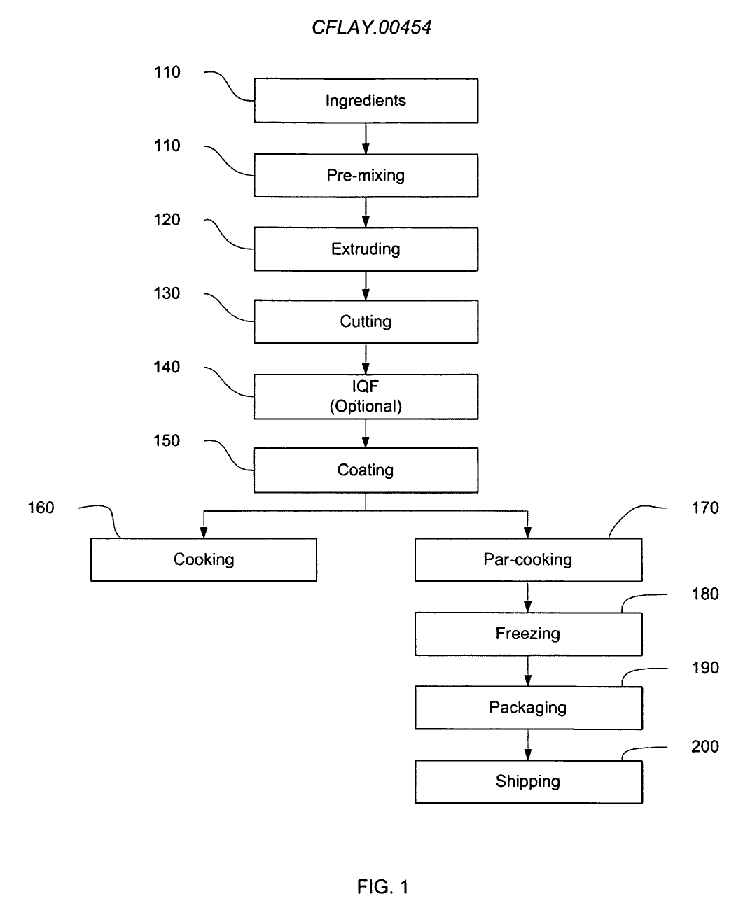

### DETAILED DESCRIPTION

The present invention is thus directed towards a method of making a vegetable containing food half product and finished product. The present invention is also directed towards a vegetable containing food half product and finished product. The product formulation for the vegetable containing food products of the present invention is a novel mixture of non-potato vegetables, starch and other ingredients that, when extruded and cooked, result in a final product with a crispy brown exterior and a soft, moist interior. In the method of the present invention, this product mixture is extruded, breaded and then cooked to produce a vegetable containing food product that is similar in shape to a French fry.

The major ingredient in the vegetable containing food products of the present invention is a pureed mixture of non-potato vegetables that have previously been cooked. Almost any non-potato vegetable., or mixture thereof, can be used with the present invention. A non-exhaustive list of suitable non-potato vegetables includes corn, peas, sweet peas, sweet corn, lima beans, asparagus, carrots, green beans, pumpkin, artichoke and squash. The particular vegetable or mixture of vegetables used in the product formulation for the present invention is largely dependent on the desired taste for the final product. The vegetable mixture must also be chosen such that the vegetable paste generated in accordance with the present invention has a viscosity within the range contemplated herein, as described in more detail below.

Another ingredient used in the present invention is potato flakes. Potato flakes comprise cooked potatoes that have been mashed, drum dried, and comminuted into flakes. The potato flakes are used to increase the viscosity of the vegetable paste used in the present invention, as they absorb water very well. Therefore, the amount of potato flakes used with the present invention depends on the water content of the vegetables used, and on the amount of water added to the vegetable paste. Suitable potato flakes for use as described herein are available from Idaho Pacific Corporation in Ririe, Id., under the brand name Potato Flakes #124. In one embodiment, the vegetable containing food product of the present invention comprises less than about 15% potato flakes by weight, and in a preferred embodiment comprises between about 5% and about 15% potato flakes by weight.

One ingredient that can optionally be used with the present invention is one or a combination of hydrocolloids. Hydrocolloids are also included as an ingredient to influence the viscosity of the vegetable paste. Hydrocolloids suitable for use with the present invention are those that readily form gels when mixed with water, and can include, for example, gelatin, agar, alginates, modified starch, native starch, locust bean gum and pectin. In one embodiment of the present invention, the vegetable containing food product comprises less than about 5% hydrocolloids by weight, and in a preferred embodiment between about 1% and about 5% hydrocolloids.

Still another optional ingredient for use in the present invention is one or a combination of visible whole food inclusions. In one embodiment, whole kernels of corn, small carrot cubes, diced onion, diced celery, seeds or whole grains, for example, can be included in the vegetable paste. The inclusions can be used to add an interesting variation on the texture and flavor of the vegetable containing food product described herein, and reinforce in the consumer's mind the fact that non-potato vegetables are being consumed.

A variety of seasonings can also be included in the product formulation of the present invention.

The method of making the vegetable containing food products of the present invention starts by pre-mixing 110 the ingredients 100 used therein. In one embodiment, vegetable puree, potato flakes and water are mixed together to form a vegetable paste. This vegetable paste is then extruded 120 through a die orifice to form a vegetable paste extrudate. If the vegetable paste is viscous enough to hold its shape upon exiting the extruder, different die orifices can be used to impart different cross sectional shapes to the extrudate. For example, an orifice having a square cross section can be used to create an extrudate approximating a traditional French fry shape. If the vegetable paste will not hold its shape upon exiting the extruder, it will generally form an extrudate with an oval or oblong cross section, and the particular shape of the die orifice is of less importance.

In one embodiment, the extruder used with the present invention is a single screw or twin screw extruder. Preferably, the extruder is not used to cook the vegetable paste because all of the ingredients are preferably cooked prior to their entry into the extruder. The extruder is primarily used to produce an extrudate having a shape that approximates a French fry shape, or other desirable shape. In one embodiment, the temperature inside the extruder is maintained below about 212° F. in order to avoid expansion of the vegetable paste upon its exit from the die orifice.

The extrudate is then cut 130 to form vegetable paste pre-forms of predetermined lengths. In one embodiment, the length of the vegetable paste pre-forms ranges between about 1 inch and about 5 inches. The particular length of the pre-forms is largely dictated by the desires of the end user. However, the viscosity of the vegetable paste may dictate the maximum manageable length for the pre-forms.

The viscosity of the vegetable paste also determines how the vegetable paste pre-forms are processed after they exit the extruder. If the paste has a viscosity of at least 500,000 centipoise, the pre-forms can immediately be breaded and cooked to form the vegetable fries of the present invention. If, however, the paste has a lower viscosity, between about 150,000 centipoise and about 500,000 centipoise, the pre-forms must be individually quick frozen 140 before they can be effectively breaded and cooked. The individual quick freezing process can be accomplished by any method known in the industry.

Next, the vegetable paste pre-form is coated 150. In one embodiment, the vegetable paste pre-form is coated with a wheat flour and egg white mixture, and then in turn coated with a breading. The breading can comprise, for example, bread crumbs, ground cereal, ground nuts or sesame seeds. It can also be nutritionally enhanced by the addition of, for example, whole grains or seeds. The breading can also be functionally enhanced by adding soluble fibers, which reduce oil absorption during frying.

The breaded pre-forms are then cooked. In one embodiment, the breaded pre-forms are cooked 160 (preferably baked or fried) to provide a final product having a crispy exterior and a warm, soft, moist interior. In an alternative embodiment, the breaded pre-forms are par-cooked 170 (preferably par-fried or par-baked) to produce half products that can be easily inserted into the supply chain used by many QSR establishments. The par-fried or par-baked half products are frozen 180 and packaged 190 in bulk so they can be shipped 200 to individual QSRs, where the half products can be finish fried or finish baked to produce the vegetable containing food products of the present invention. In one embodiment, the half products have a moisture content between about 30% and about 60% by weight. The finished vegetable containing food products can easily be prepared and served at a QSR in a manner similar to the way French fries are prepared and served. In one embodiment, the finished food product has a moisture content between about 30% and about 50% by weight. Consumers who perceive French fries to be an unhealthy side dish will be more likely to view the vegetable containing food products of the present invention as a healthier alternative to French fries, and thus be more likely to consume them.

The invention has been fully described above, but can be further illustrated by referring to the following examples:

### EXAMPLE 1

A mixed vegetable puree comprising corn, peas, lima beans, asparagus and carrots was combined with chicken broth, potato flakes and seasoning in a mixer to create a vegetable paste. The vegetable paste comprised about 40% mixed vegetable puree, about 33% chicken broth, about 14% potato flakes, and about 2% seasoning, and had a viscosity of about 800,000 centipoise. All percentages used herein are by total weight of the product unless otherwise indicated. Chicken broth was used in place of water to give the vegetable containing food product a savory flavor. The vegetable paste was extruded through an orifice having a circular cross sectional shape approximately ⅓ inch in diameter. The extruded vegetable paste was cut into pre-forms approximately 3.5 inches in length.

The pre-forms were then breaded and fried at an oil temperature of about 360° F. to a final moisture content of approximately 48% by weight of the fnal product. The final product had a crispy outer layer surrounding a warm, soft, moist inner layer. It was also a savory and delicious food item.

### EXAMPLE 2

A mixed vegetable puree comprising sweet corn and sweet peas was combined with chicken broth, potato flakes and parmesan cheese in a mixer to create a vegetable paste. The vegetable paste comprised about 61% mixed vegetable puree (about 35% sweet pea and about 26% sweet corn), about 11% chicken broth, about 12% potato flakes, and about 5% parmesan cheese, and had a viscosity of about 850,000 centipoise. The vegetable paste was extruded through an orifice having a circular cross sectional shape approximately ⅓ inch in diameter. The extruded vegetable paste was cut into pre-forms approximately 3.5 inches in length.

The pre-forms were then breaded and fried at an oil temperature of about 360° F. to a final moisture content of approximately 48% by weight of the final product. The final product had a crispy outer layer surrounding a warm, soft, moist inner layer. It was also a savory and delicious food item.

### EXAMPLE 3

A mixed vegetable puree comprising sweet corn and sweet peas was combined with whole kernels of sweet corn, chicken broth, potato flakes and parmesan cheese in a mixer to create a vegetable paste. The vegetable paste comprised about 49% mixed vegetable puree (about 28% sweet pea and about 21% sweet corn), about 18% sweet corn kernels, about 9% chicken broth, about 10% potato flakes, and about 4% parmesan cheese, and had a viscosity of about 850,000 centipoise. The vegetable paste was extruded through an orifice having a circular cross sectional shape approximately ⅓ inch in diameter. The extruded vegetable paste was cut into pre-forms approximately 3.5 inches in length.

The pre-forms were then breaded and fried at an oil temperature of about 360° F. to a final moisture content of approximately 48% by weight of the final product. The final product had a crispy outer layer surrounding a warm, soft, moist inner layer. It was also a savory and delicious food item.

The products, from each of the foregoing examples had a size and shape that would allow them to be served and eaten in much the same manner as traditional French fries are served and eaten at QSRs. Namely, existing paper cups or paper sleeves used by QSRs can be filled with these vegetable containing food products of the present invention and distributed to the consumer with minimal interruption in the supply chain. Some of the pre-forms from the foregoing examples were par-fried to a moisture content of about 53%, before being finish fried to a final moisture content of about 48%.

While the invention has been particularly shown and described with reference to a preferred embodiment and several examples, it will be understood by those skilled in the art that various changes in form and detail may be made therein without departing from the spirit and scope of the invention.

What is claimed is:

1. A method for making a vegetable containing food product, said method comprising:
mixing ingredients comprising a non-potato vegetable puree, potato flakes and water to form a vegetable paste having a viscosity of at least about 150,000 centipoise;
extruding said vegetable paste to produce an extrudate;
cutting said extrudate to produce a pre-form having a predetermined length;
coating said pre-form to produce a coated pre-form; and
cooking said coated pre-form to a moisture content between about 30% and about 60% by total product weight to produce a vegetable containing food product.

2. The method of claim 1 wherein said ingredients further comprise whole vegetable inclusions.

3. The method of claim 1 wherein said ingredients further comprise hydrocolloids.

4. The method of claim 1 wherein said length of said pre-form is between about 1 inch and about 5 inches.

5. The method of claim 1 wherein said viscosity of said vegetable paste is between about 150,000 centipoise and about 500,000 centipoise, and wherein said method further comprises:
individually quick freezing said pre-form prior to said coating.

6. The method of claim 1 wherein said cooking comprises at least one of baking and frying.

7. The method of claim 1 wherein said moisture content is between about 30% and about 50%.

8. The method of claim 1 wherein said non-potato vegetable puree comprises corn, pea, lima bean, asparagus and carrot.

9. The method of claim 1 wherein said non-potato vegetable puree comprises sweet corn and sweet pea.

10. The method of claim 2 wherein said whole vegetable inclusions comprise at least one of kernels of corn, whole grains, diced onions, diced celery, seeds and carrot cubes.

11. The method of claim 1 wherein said coating further comprises:
coating said pre-form with a flour and egg white mixture; and
covering said pre-form with a breading mixture comprising at least one of bread crumbs, ground cereal, ground nuts and seeds.

12. The method of claim 11 wherein said breading mixture further comprises at least one of whole grains and soluble fibers.

13. The method of claim 3 wherein said hydrocolloids comprise at least one of gelatin, agar, alginates, modified starch, native starch, locust bean gum and pectin.

14. A vegetable containing food product comprising:
at least 40% non-potato vegetable puree by weight;
less than about 15% potato flakes;
less than about 5% hydrocolloids;
a coating; and
a moisture content between about 30% and about 60%.

15. The food product of claim 14 further comprising between about 1% and about 5% hydrocolloids.

16. The food product of claim 14 further comprising whole vegetable inclusions.

17. The food product of claim 16 wherein said whole vegetable inclusions further comprise at least one of kernels of corn, whole grains, diced onions, diced celery, seeds and carrot cubes.

18. The food product of claim 14 wherein said coating comprises a mixture of egg white, flour and bread crumbs.

19. The food product of claim 18 wherein said coating further comprises at least one of whole grains, soluble fibers, ground cereal, ground nuts and seeds.

20. The food product of claim 14 further comprising a length between about 1 inch and about 5 inches.
